(19) United States
(12) Patent Application Publication
(10) Pub. No.: US 2015/0363591 A1
(43) Pub. Date: Dec. 17, 2015

(54) METHOD OF ACTIVATE UPON AUTHENTICATION OF ELECTRONIC DEVICE

(71) Applicant: AirSig Inc., Grand Cayman (KY)

(72) Inventor: PO-KAI CHEN, Grand Cayman (KY)

(21) Appl. No.: 14/741,437

(22) Filed: Jun. 16, 2015

Related U.S. Application Data
(60) Provisional application No. 62/013,227, filed on Jun. 17, 2014.

(51) Int. Cl. G06F 21/44; G06F 21/34; G06F 21/31

(52) U.S. Cl. CPC G06F 21/445; G06F 21/31; G06F 21/34; G06F 2221/031

(57) ABSTRACT

A method of activate-upon-authentication for an electronic device is disclosed. The method includes following steps: accepting a first user operation corresponding to specific function; generating input data corresponding to the first user operation; authenticating a user identity, and simultaneously obtaining a control command corresponding to the predefined input data for triggering the function when the input data matching one of a plurality of predefined input data previously established; and executes the control command in order to trigger above-mentioned function. The present invention uses a single user operation to identify user identity and trigger above-mentioned function at the same time, which eliminates the need to execute additional operation to input identification data.

### CROSS-REFERENCE TO RELATED APPLICATION

This patent application claims the benefit of U.S. Provisional Patent Application No. 62/013,227, filed Jun. 17, 2014, which is incorporated by reference herein.

### BACKGROUND OF THE INVENTION

1. Field of the Invention

The present invention relates to an authentication method, in particular relates to a method of activate-upon-authentication.

2. Description of Prior Art

FIG. 1 is a flowchart of authentication control method of related art. As shown in FIG. 1, when a user wants to trigger a specific function (for example launching an application) with an electronic device (for example smart phone), the user has to perform an identity data input operation to input identity data (for example an unlock password of the electronic device) (step S10). Next, the electronic device performs authentication on the identity data (step S12), and if the identity data is determined correct in the authentication, the user identity is authenticated, and the user is permitted to continue to trigger a user operation of the function (for example click on an icon of an application displayed on the electronic device) (step S14). Lastly, the electronic device executes a control command corresponding to the user operation (step S16) to trigger corresponding function (for example launching the application).

As mentioned above, in the authentication control method of the related art, the user has to perform two operations (firstly performs the identity data input operation, then performs the user operation) to proceed to perform identity authentication and trigger corresponding function (i.e. launching the application), which is complicated. Such method may be inconvenient to the user operation and offers inferior user experiences.

The authentication control method of the related art has above-mentioned issues and accordingly it is desired to provide methods with better efficiency.

### SUMMARY OF THE INVENTION

The objective of the present invention is to provide a method of activate-upon-authentication in order to perform authentication based on the user operation corresponding to the intended function of the user and execute the intended function simultaneously.

In order to achieve the above-mentioned objective, the present invention provides a method of activate-upon-authentication for an electronic device, comprising following steps:

a) accepting a first user operation corresponding to a function input by a user;

b) generating input data corresponding to the first user operation;

c) when the input data upon determined matching one of a plurality of predefined input data established previously, authenticating a user identity, and simultaneously obtaining a control command corresponding to the predefined input data for triggering the function; and

d) executing the control command for triggering the function.

According to the present invention, when accepting an input user operation to trigger a specific function requested by the user, the above-mentioned function is triggered and user identity is authenticated at the same time, which effectively eliminates the need to execute additional operation to input identity data.

### BRIEF DESCRIPTION OF DRAWING

The features of the invention believed to be novel are set forth with particularity in the appended claims. The invention itself, however, may be best understood by reference to the following detailed description of the invention, which describes exemplary embodiments of the invention, taken in conjunction with the accompanying drawings, in which:

FIG. 1 is a flowchart of authentication control method of related art;

FIG. 2 is an electronic device architecture diagram of the first embodiment according to the present invention;

FIG. 3 is a flowchart of the method of activate-upon-authentication of the first embodiment according to the present invention;

FIG. 4 is a partial flowchart of the method of activate-upon-authentication of the second embodiment according to the present invention;

FIG. 5A is a flowchart of the method of activate-upon-authentication of the third embodiment according to the present invention;

FIG. 5B is a user operation schematic diagram of the third embodiment according to the present invention;

FIG. 6A is a flowchart of the method of activate-upon-authentication of the fourth embodiment according to the present invention;

FIG. 6B is the first user operation schematic diagram of the fourth embodiment according to the present invention;

FIG. 6C is the second user operation schematic diagram of the fourth embodiment according to the present invention;

FIG. 7 is a flowchart of the method of activate-upon-authentication of the fifth embodiment according to the present invention;

FIG. 8 is a flowchart of the method of activate-upon-authentication of the sixth embodiment according to the present invention;

FIG. 9A is a flowchart of the method of activate-upon-authentication of the seventh embodiment according to the present invention;

FIG. 9B is the first user operation schematic diagram of the seventh embodiment according to the present invention;

FIG. 9C is the second user operation schematic diagram of the seventh embodiment according to the present invention; and

FIG. 10 is a flowchart of the method of activate-upon-authentication of the eighth embodiment according to the present invention.

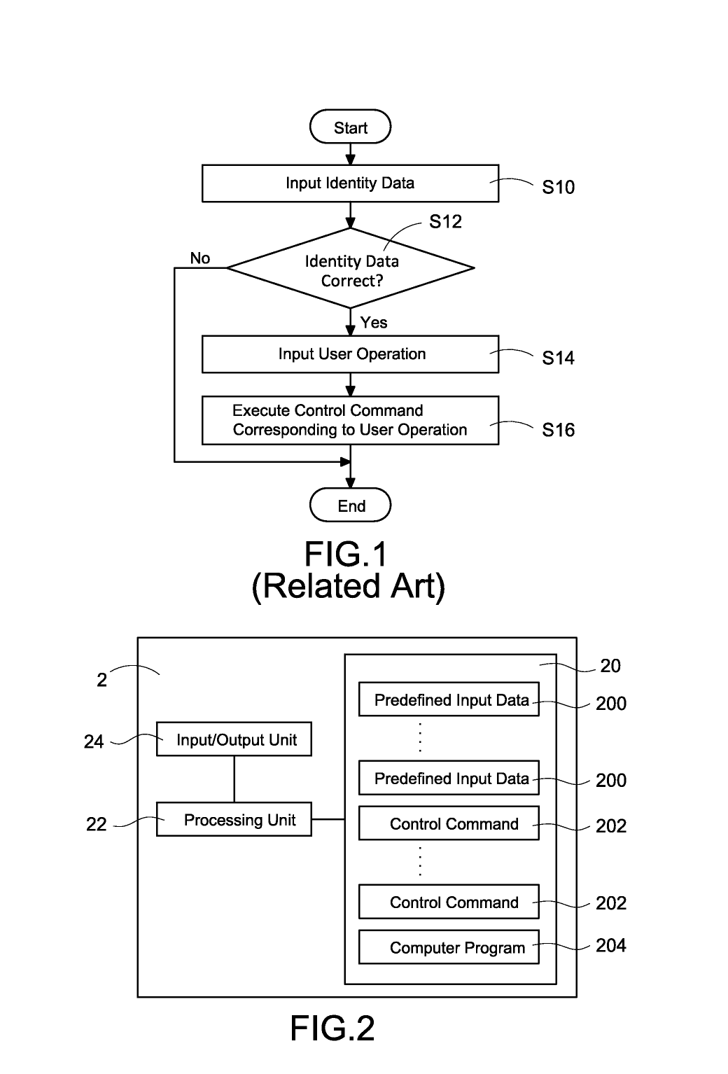

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

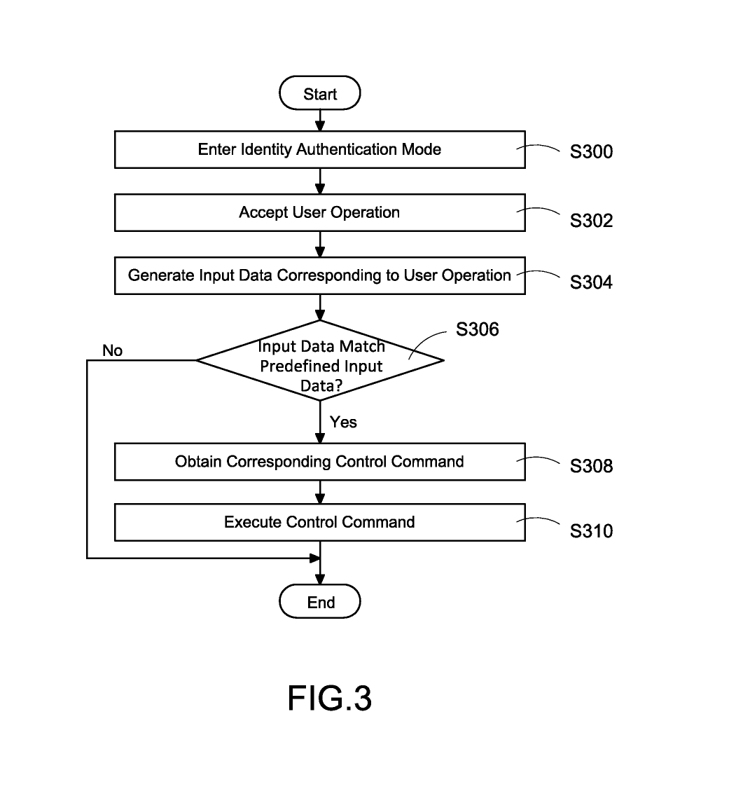

Refer to FIG. 2 and FIG. 3, FIG. 2 is an electronic device architecture diagram of the first embodiment according to the present invention, and FIG. 3 is a flowchart of the method of activate-upon-authentication of the first embodiment according to the present invention.

As shown in FIG. 2, an electronic device 2 comprises a storage unit 20, a processing unit 22 and an input/output unit 24. Preferably, the electronic device 2 is a smart phone, a tablet, a notebook computer, a wearable device (for example a smart bracelet or a smart ring) or any combination of the above devices, but is not limited thereto.

A plurality of predefined input data 200 and a plurality of control commands 202 are saved in the storage unit 20. The plurality of predefined input data 200 respectively corresponds to the plurality of control commands 202. The plurality of control command 202 are respectively for triggering a function of/from the electronic device 2 (for example launching a predefined application and/or executing predefined device control).

The processing unit 22 electrically connects to the storage unit 20 and the input/output unit 24, and is used for controlling each components of the electronic device 2.

The input/output unit 24 is used for accepting a user operation from a user, and providing feedback information to the user (for example displaying a picture or play sounds).

Preferably, the input/output unit 24 is a writing input device (for example an electronic pen or a touchpad), an audio input device (for example a microphone), an image capturing device (for example a camera, a visible light camera or an infrared camera), a sensor (for example a motion sensor), an object identification device (for example a wired smart card reader, a wireless smart card reader (for example a RFID card reader or an NFC card reader) or a barcode scanner), a human machine interface (for example a touchscreen, a speaker, a keyboard or a mouse) or any combination of the above devices, but is not limited thereto.

The embodiments of the method of activate-upon-authentication are used in the electronic device 2 shown in FIG. 2. Specifically, a computer program 204 is further saved in the storage unit 20. After the processing unit 22 executes the computer program 204, each step of the method of activate-upon-authentication in each embodiment is executed.

Table 1 is an example of corresponding relations among user, predefined input data and control command in the embodiment, which is used for illustrating the corresponding relations in the embodiment. Preferably, Table 1 is saved in the storage unit 20 used as data. In the example illustrated in the following embodiment description with Table 1, the input/output unit 24 is the keyboard, and the function is launching the predefined application 1.

TABLE 1

| user | predefined input data | control command |
|---|---|---|
| John | Npass123 | Execute notepad app |
| | secretCam | Execute camera app |
| | mailPassword | Execute mail app |

The embodiment of the method of activate-upon-authentication comprises following steps shown in FIG. 3:

Step S300: the electronic device 2 enters an authentication mode.

Step S302: the electronic device 2 accepts the user operation (for example a first user operation). Preferably, the electronic device 2 accepts the user operation via the input/output unit 24, and the user operation corresponds to the function which the user wants to execute.

For example, the user “John” respectively inputs a string “John” and a string “Npass123” to the electronic device 2 via the keyboard in order to complete the user operation.

Step S304: the electronic device 2 generates input data corresponding to the user operation. Preferably, the electronic device 2 generates the input data corresponding to the user operation and readable by the computer according to the accepted user operation.

For example, the electronic device 2 generates the input data “John” corresponding to the string “John” and the input data “Npass123” corresponding to the string “Npass123”.

Step S306: the electronic device 2 determines whether if the input data matches one of the plurality of predefined input data 200. Preferably, the plurality of predefined input data 200 was previously saved in the storage unit 20 by the user, and respectively corresponds to different control commands 202.

If the electronic device 2 determines that the input data matches one of the plurality of predefined input data 200, the user identity is authenticated, and the electronic device 2 executes step S308. Otherwise, the input/output unit 24 sends warnings and the method of activate-upon-authentication is terminated. That is, the authentication of the user identity fails, and the electronic device 2 is not allowed to execute any function.

For example, the electronic device 2 determines if the user identity “John” is authenticated according to the input data “John”, then performs an inquiry in Table 1 and a comparison in order to determine whether if the input data is same with one of the predefined input data 200 (including “Npass123”, “secretCam” and “mailPassword”) previously established by the user “John”.

In the embodiment, when the electronic device 2 determines with reference to Table 1 that the input data is same with the input data “Npass123” predefined by the user “John”, accordingly it is confirmed that the user is “John”, and the user identity is authenticated.

Step S308: the electronic device 2 obtains the control command 202 corresponding to the predefined input data 200.

For example, when the electronic device 2 determines the input data matching the predefined input data “Npass123” previously established, the electronic device 2 obtains the corresponding control command “Execute notepad app” in the storage unit 20 according to Table 1.

Step S310: the electronic device 2 executes the obtained control command 202 to trigger the function.

For example, the electronic device 2 executes the obtained control command “Execute notepad app” in order to trigger the function to launch a notebook application.

Accordingly, the method of the present invention uses single user operation for performing the authentication of the user identity and executes the control command for triggering the corresponding function at the same time. And, the method of the present invention performs authentication on the same user identity via different user operations, and triggers respective different functions, which are convenient to users.

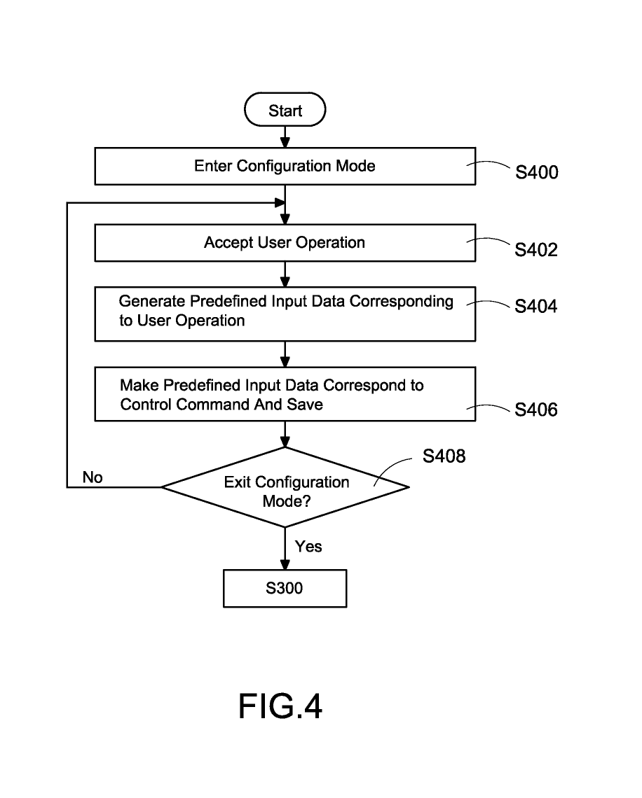

FIG. 4 is a partial flowchart of the method of activate-upon-authentication of the second embodiment according to the present invention. In the embodiment, the method of activate-upon-authentication further comprises following steps before the step S300:

Step S400: the electronic device 2 enters a configuration mode.

Step S402: the electronic device 2 accepts the user operation (for example a second user operation). Preferably, the electronic device 2 accepts the user operation via the input/output unit 24, and the user operation is associated with the function which the user wants to trigger.

For example, the user respectively inputs a string “John” and a string “secretCam” to the electronic device 2 via the keyboard in order to complete the user operation.

Step S404: the electronic device 2 generates operation data corresponding to the user operation as one of the plurality of predefined input data 200.

For example, the electronic device 2 generate the predefined input data “John” and the predefined input data “secretCam” corresponding to the input string to process in following steps.

Step S406: the electronic device 2 matches the predefined input data 200 to the plurality of control command 202 and saves the predefined input data 200. Preferably, the electronic device 2 firstly accepts a configuration operation of the user, makes the predefined input data 200 correspond to the control command 202 for triggering the function selected by the user according to the configuration operation, and saves the above-mentioned corresponding relations in the storage unit 20.

For example, the electronic device 2 determines that the electronic device 2 performs configuration operation on the data of the user “John” according to the predefined input data “John”, then modifies the saved Table 1 according to the configuration operation in order to make the predefined input data “secretCam” of the user “John” correspond to the control command “Execute camera”.

It should be noted that, the electronic device 2, for example as mentioned previously first confirmed the user identity, then makes the predefined input data 200 correspond to the control command 202 for triggering the function according to the configuration operation.

Next, the electronic device 2 can also proceed without confirming the user identity, make the predefined input data 200 correspond to the user (for example the user “John”) and at the same time correspond to the control command 202 of the function for triggering the function selected by the user according to the configuration operation.

Step S408: the electronic device 2 detects whether if the configuration mode is exited. If it detects that the configuration mode is not exited, the electronic device 2 accepts another second user operation in order to generate another predefined input data 200 (for example “mailPassword” in Table 1), and make another predefined input data 200 correspond to another control command 202 for triggering another function via the configuration operation. If the configuration mode is exited, the electronic device 2 executes the step S300.

Accordingly, the user is allowed to customize a plurality of the user operations under the configuration mode, and make a plurality of the user operations respectively correspond to the plurality of control commands for triggering different function. Additionally, the plurality of the user operations are used for authenticating the user identity.

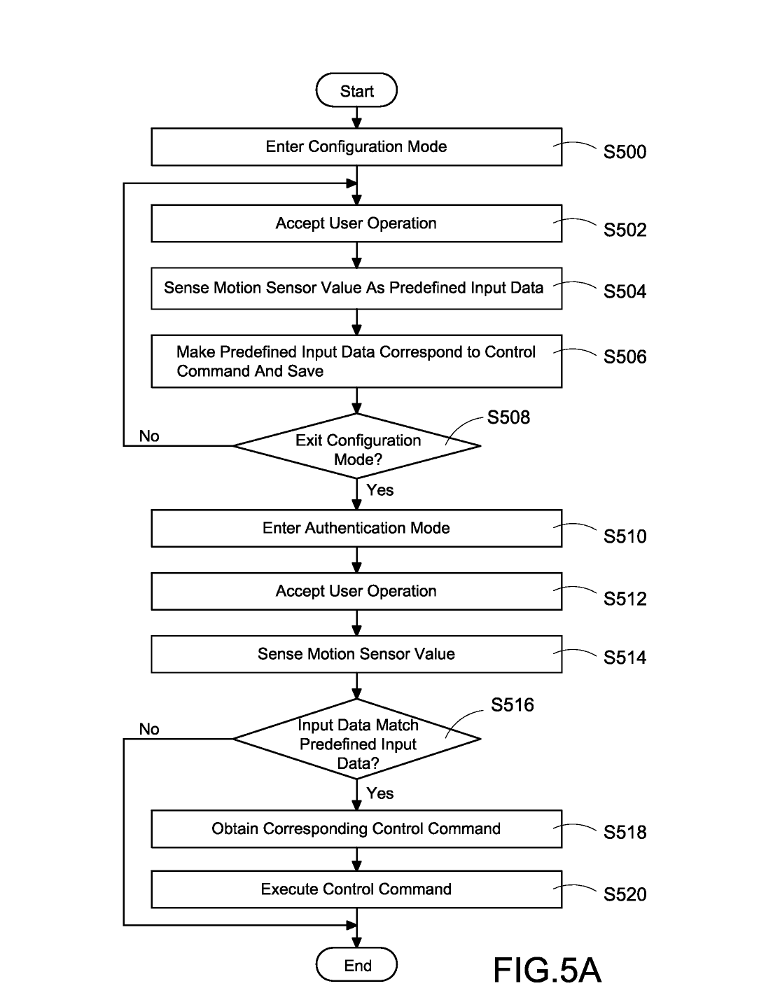

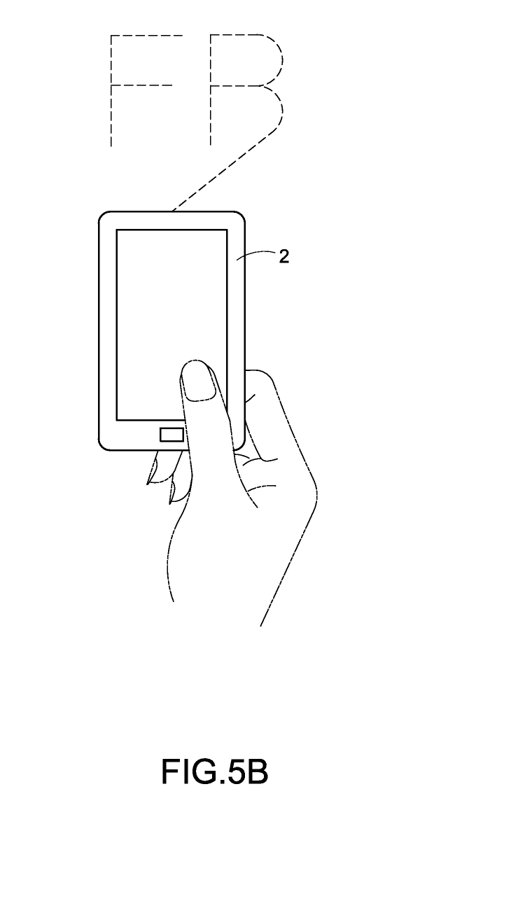

Refer to FIG. 5A, FIG. 5B and Table 2, FIG. 5A is a flowchart of the method of activate-upon-authentication of the third embodiment according to the present invention and FIG. 5B is a user operation schematic diagram of the third embodiment according to the present invention.

Table 2 is a second example for corresponding relations table among user, predefined input data and control command in the present embodiment, which is used for illustrating the corresponding relations in the embodiment. Preferably, Table 2 is saved in the storage unit 20 used as data. In the example illustrated in the following embodiment description with Table 2, the input/output unit 24 is a motion sensor, and the function is launching the predefined application 1.

TABLE 2

| user | predefined input data | control command |
|---|---|---|
| John | FB | Execute facebook app |
| | mail | Execute mail app |
| Sally | FB | Execute facebook app |
| | mail | Execute mail app |

The embodiment of the method of activate-upon-authentication comprises following steps:

Step S500: the electronic device 2 enters the configuration mode.

Step S502: the electronic device 2 accepts the user operation (i.e. the second user operation). Preferably, the user moves the electronic device 2 along a path (i.e. a second path) in the air in order to complete the user operation.

As an example as shown in FIG. 5B, the user “John” uses the electronic device 2 to serve as a pen to write a word or a symbol (such as writing a word “FB”) in order to complete the user operation.

Step S504: the electronic device 2 senses a motion sensor value (i.e. a second motion sensor value) corresponding to the user operation via the motion sensor and uses the second motion sensor value as the predefined input data 200.

For example, the electronic device 2 generates the corresponding predefined input data “FB” according to the user operation (the predefined input data “FB” is the motion sensor value generated by the user “John” writing the word “FB” in the air) to process in following steps.

Step S506: the electronic device 2 accepts the configuration operation from the user to make the predefined input data 200 correspond to the user identity and correspond to the control command 202 for triggering the function selected by the user, and save the above-mentioned corresponding relations in the storage unit 20. Specifically, because the writing habits and writing paths are different for each user, the motion sensor values generated according to each user's writing behaviors are different. Accordingly the predefined input data 200 also serves as a means for authenticating user identity.

For example, if the user wants to make the predefined input data 200 correspond to a function of launching Facebook application, the electronic device 2 modifies the saved Table 2 according to the configuration operation in order to make the predefined input data “FB” correspond to the user “John” and the control command “Execute Facebook app”.

Step S508: the electronic device 2 detects whether if the configuration mode is exited. If it detects that the configuration mode is not exited, the electronic device 2 accepts other user operations (for example other user operations from the user “John” or other user operations from another user “Sally”), and sets up corresponding control command(s) 202. Otherwise, the electronic device 2 executes the step S510.

Step S510: the electronic device 2 enters the authentication mode.

Step S512: the electronic device 2 accepts the user operation (i.e. the first user operation). Preferably, the user moves the electronic device 2 along a path (i.e. a first path) in the air in order to complete the user operation.

For example, as an example as shown in FIG. 5B, another user “Sally” uses the electronic device 2 to serve as a pen to write a word or a symbol (such as writing a word “FB”) in order to complete the user operation.

Step S514: the electronic device 2 senses a motion sensor value (i.e. a first motion sensor value) corresponding to the user operation via the motion sensor used as the input data.

For example, the electronic device 2 generates the corresponding input data “FB” according to the user operation (the input data “FB” is the motion sensor value generated by the user “Sally” writing the word “FB” it the air).

Step S516: the electronic device 2 determining whether if the input data matches one of the plurality of predefined input data 200. If the electronic device 2 determines the input data matching one of the plurality of predefined input data 200, the user identity is authenticated, and the electronic device 2 executes step S518. Otherwise, the method of activate-upon-authentication is terminated by the electronic device 2.

For example, the electronic device 2 performs an inquiry in the Table 2 and a comparison to determine that the input data corresponds to the predefined input data “FB” of the user “Sally”, and the user identity “Sally” is authenticated.

Step S518: the electronic device 2 obtains the control command 202 corresponding to the predefined input data 200.

For example, the electronic device 2 reads the control command “Execute facebook app” corresponding to the predefined input data “FB” of the user “Sally” in the storage unit 20 according to Table 2.

Step S520: the electronic device 2 executes the obtained control command 202 in order to trigger the function.

For example, the electronic device 2 executes the control command “Execute facebook app” in order to launch a facebook application, and uses the user identity “Sally” to logon.

It should be noted that, each person's writing habits is different, even if the user “John” and the user “Sally” both hold the electronic device 2 and writing “FB” in the air, the electronic device 2 is capable of determining the user identity according to writing paths without confusion. In the embodiment of the method of activate-upon-authentication, the generated input data and the generated predefined input data 200 are unique to every user. Providing other people perform the same user operation, the input data generated is not completely identical.

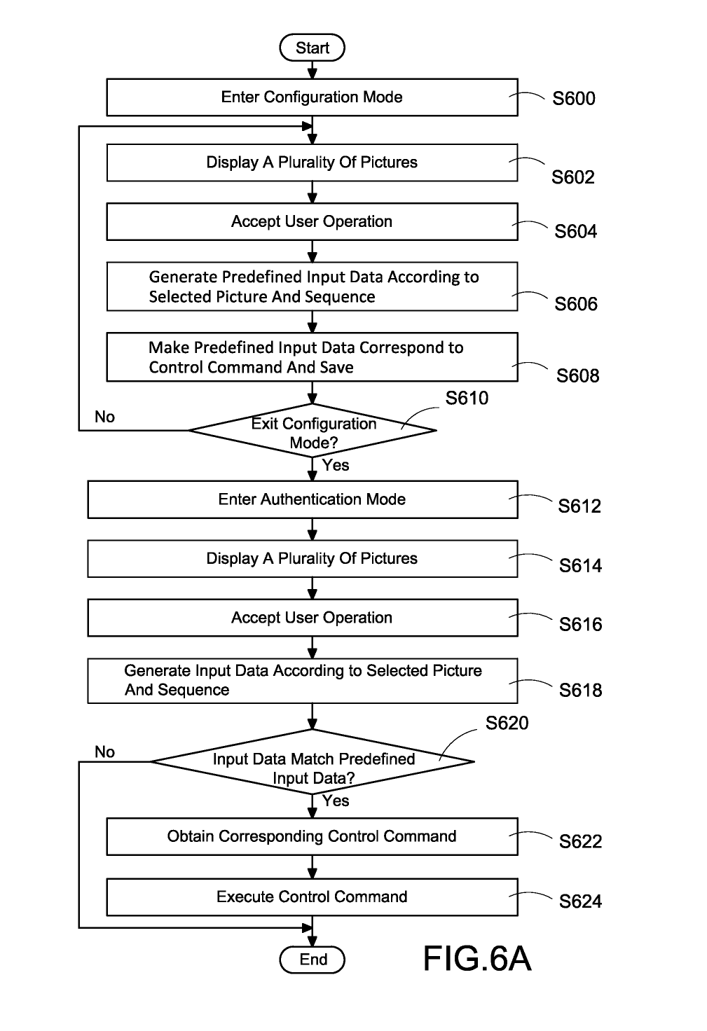

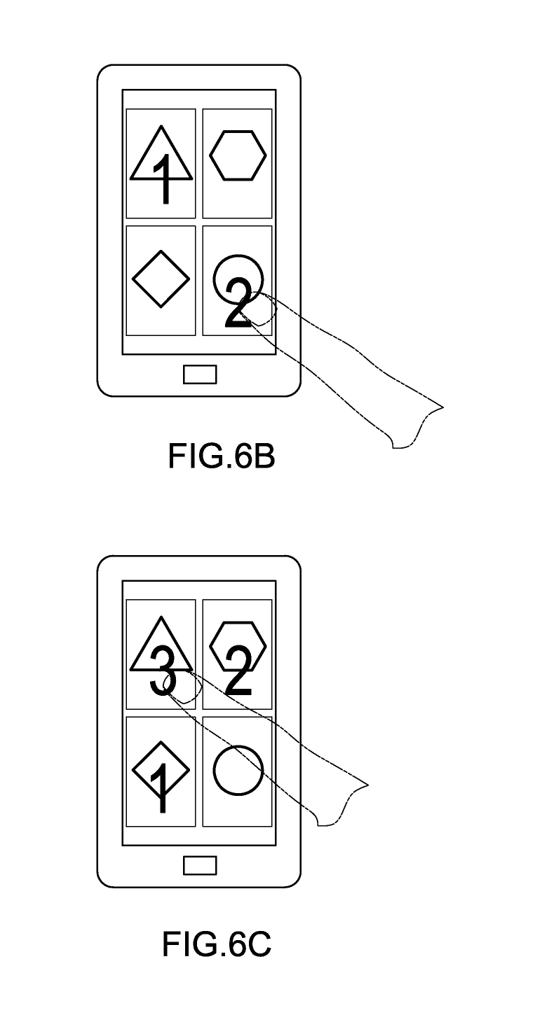

Refer to FIG. 6A, FIG. 6B, FIG. 6C and Table 3, FIG. 6A is a flowchart of the method of activate-upon-authentication of the fourth embodiment according to the present invention, FIG. 6B is the first user operation schematic diagram of the fourth embodiment according to the present invention, and FIG. 6C is the other user operation schematic diagram of the fourth embodiment according to the present invention.

Table 3 is the third example of corresponding relations among user, predefined input data and control command in the embodiment, which is used for illustrating the corresponding relations in the embodiment. Preferably, Table 3 is saved in the storage unit 20 used as data (not shown in the diagrams). In the example illustrated in the following embodiment description with Table 3, the input/output unit 24 is a touchscreen, and the function is launching the predefined application.

TABLE 3

| user | predefined input data | control command |
|---|---|---|
| John | triangle →circle | Execute camera app |
| | diamond →hexagon→triangle | Execute mail app |

The embodiment of the method of activate-upon-authentication comprises following steps:

Step S600: the electronic device 2 enters the configuration mode.

Step S602: the electronic device 2 displays a plurality of picture (i.e. a plurality of second picture) via the touchscreen. Preferably, the displayed plurality of pictures are identical or different.

Step S604: the electronic device 2 accepts the user operation of selecting parts of the plurality of pictures (i.e. the second user operation) via the touchscreen.

For example, as the example shown in FIG. 6B, the user “John” selects the picture “triangle” and the picture “circle” according to a sequence in order to complete the user operation.

Step S608: the electronic device 2 generates the predefined input data 200 according to the selected parts of the plurality of pictures. Preferably, the electronic device 2 further generates the predefined input data 200 according to a sequence of selected parts of the plurality of pictures (i.e. a second sequence).

For example, the electronic device 2 generates the corresponding predefined input data “triangle→circle” according to selected picture and the sequence to process in following steps.

Step S608: the electronic device 2 accepts the configuration operation by the user to make the predefined input data 200 correspond to the user identity and correspond to the control command 202 for triggering the function selected by the user and saves the corresponding relations.

For example, the electronic device 2 modifies the saved Table 3 and makes the predefined input data “triangle→circle” correspond to the user “John” and the control command “Execute camera app”.

Step S610: the electronic device 2 detects whether if the configuration mode is exited. If it detects that the configuration mode is not exited, the electronic device 2 can accept other user operations and configure corresponding users and corresponding control commands 202. Otherwise, the electronic device 2 executes the step S612.

Step S612: the electronic device 2 enters the authentication mode.

Step S614: the electronic device 2 displays a plurality of picture (i.e. a plurality of first picture) via the touchscreen. Preferably, the displayed plurality of pictures are at least partially identical or different with the plurality of first picture.

Step S616: the electronic device 2 accepts the user operation of selecting parts of the plurality of pictures (i.e. the first user operation) via the touchscreen

For example, as the example shown in FIG. 6C, the user “John” selects the picture “diamond”, the picture “hexagon” and the picture “triangle” according to a sequence in order to complete the user operation

Step S618: generating the input data according to the selected parts of the plurality of pictures and the sequence (i.e. a first sequence).

For example, the electronic device 2 generates the corresponding input data “diamond→hexagon→triangle” according to selected picture and the sequence.

Step S620: the electronic device 2 determines whether if the input data matches one of the plurality of predefined input data 200. If the electronic device 2 determines the input data matching one of the plurality of predefined input data 200, the user identity is authenticated, and the electronic device 2 executes step S622. Otherwise, the method of activate-upon-authentication is terminated by the electronic device 2.

For example, the electronic device 2 performs an inquiry in the Table 3 and a comparison to determine that the input data corresponds to the predefined input data “diamond→hexagon→triangle” of the user “John”, and the user identity “John” is authenticated.

Step S622: electronic device 2 obtains the control command 202 corresponding to the predefined input data 200.

For example, the electronic device 2 reads the control command “Execute mail app” corresponding to the predefined input data “diamond→hexagon→triangle” in the storage unit 20 according to Table 3.

Step S624: the electronic device 2 executes the obtained control command 202 in order to trigger the function.

For example, the electronic device 2 executes the control command “Execute mail app” in order to launch the mail application.

It should be noted that, human beings have better memorizing capability of pictures than words. In the present invention, combinations of pictures are used as an authentication key, which provides high security level and an authentication mechanism easy to memorize. Also, in the present invention, the electronic device 2 performs identity authentication and executes corresponding control command at the same time in order to trigger corresponding functions, whereby users have optimized operation experiences.

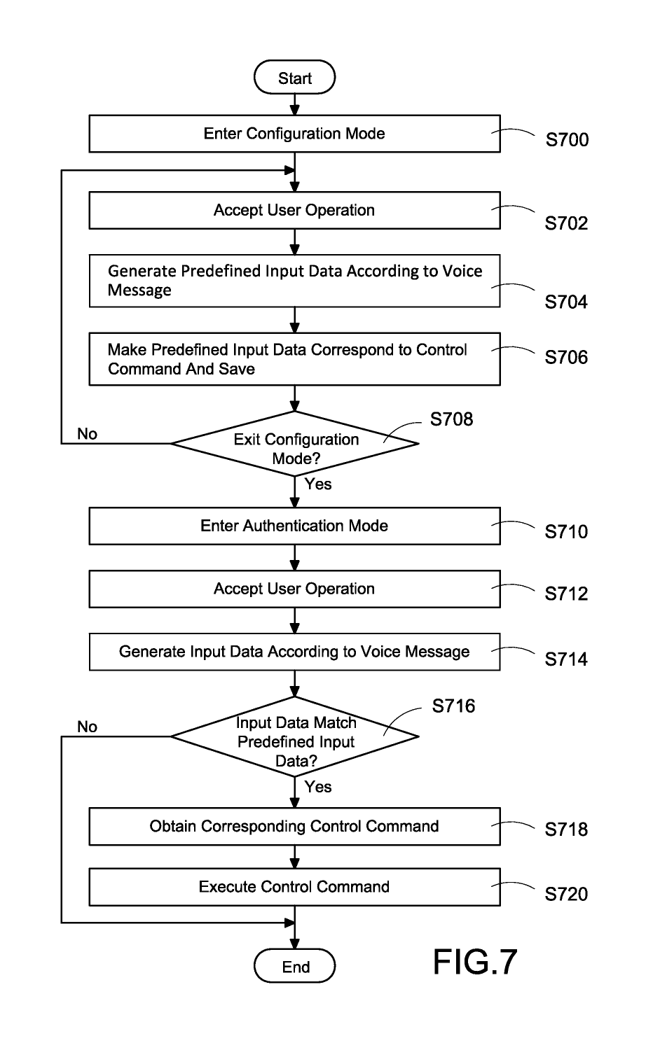

Refer to FIG. 7 and Table 4, FIG. 7 is a flowchart of the method of activate-upon-authentication of the fifth embodiment according to the present invention.

Table 4 is the fourth example of corresponding relations among user, predefined input data and control command in the embodiment, which is used for illustrating the corresponding relations in the embodiment. Preferably, Table 4 is saved in the storage unit 20 used as data (not shown in the diagrams). In the example illustrated in the following embodiment description with Table 4, the input/output unit 24 is a microphone, and the function is launching the predefined application.

TABLE 4

| user | predefined input data | control command |
|---|---|---|
| John | NOTEPAD | Execute notepad app |
| | CAMERA | Execute camera app |
| | EMAIL | Execute mail app |

The embodiment of the method of activate-upon-authentication comprises following steps:

Step S700: the electronic device 2 enters the configuration mode.

Step S702: the electronic device 2 accepts the user operation (i.e. the second user operation) of inputting a voice message (i.e. a second voice message).

For example, the user “John” inputs the voice message “NOTEPAD” in order to complete the user operation.

Step S704: the electronic device 2 generates voice data (i.e. second voice data) as the predefined input data 200 according to the voice message.

For example, the electronic device 2 generates the voice data “NOTEPAD” corresponding the voice message used as the predefined input data 200 to process in the following steps.

Step S706: the electronic device 2 accepts the configuration operation by the user to make the predefined input data 200 correspond to the user identity and correspond to the control command 202 for triggering the function selected by the user (for example correspond to control command “Execute notepad app”) and saves the corresponding relations.

Step S708: the electronic device 2 detects whether if the configuration mode is exited. If it detects that the configuration mode is not exited, the electronic device 2 can accept other user operations and configure corresponding users and corresponding control commands 202. Otherwise, the electronic device 2 executes the step S710.

Step S710: the electronic device 2 enters the authentication mode.

Step S712: the electronic device 2 accepts the user operation (i.e. the first user operation) of inputting a voice message (i.e. a first voice message).

For example, the user “John” inputs the voice message “EMAIL” in order to complete the user operation.

Step S714: the electronic device 2 generates voice data (i.e. first voice data) used as the input data 200 according to the voice message.

For example, the electronic device 2 generates the voice data “EMAIL” corresponding the voice message used as the input data.

Step S716: the electronic device 2 determines whether if the input data matches one of the plurality of predefined input data 200. If the electronic device 2 determines the input data matching one of the plurality of predefined input data 200, the user identity is authenticated, and the electronic device 2 executes step S718. Otherwise, the method of activate-upon-authentication is terminated by the electronic device 2.

For example, the electronic device 2 performs an inquiry in the Table 4 and a comparison to determine that the input data corresponds to the predefined input data “EMAIL” of the user “John”, and the user identity “John” is authenticated.

Step S718: electronic device 2 obtains the control command 202 corresponding to the predefined input data 200.

For example, the electronic device 2 obtains the control command “Execute mail app” corresponding to the predefined input data “EMAIL” according to Table 4.

Step S720: the electronic device 2 executes the obtained control command 202 in order to trigger the function.

For example, the electronic device 2 executes the control command “Execute mail app” in order to launch the mail application.

It should be noted that, each person has different voices, according to the embodiment of the method of activate-upon-authentication, the generated input data and the predefined input data 200 are unique to each person, even other people perform the same user operation, the generated input data is not completely identical

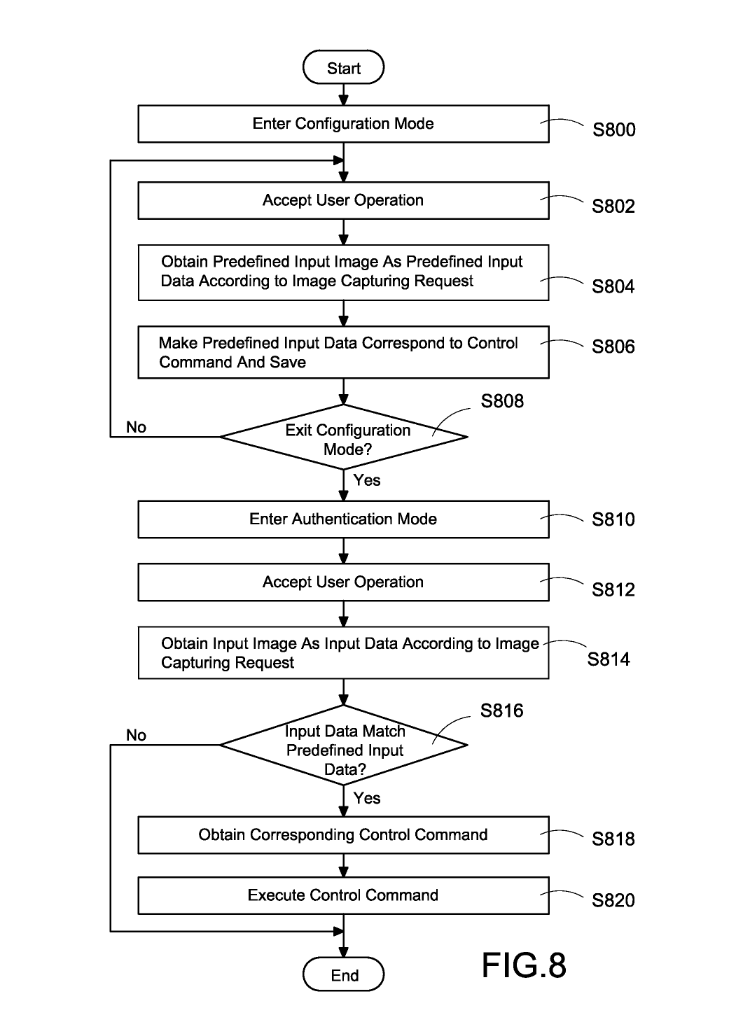

Refer to FIG. 8 and Table 5, FIG. 8 is a flowchart of the method of activate-upon-authentication of the sixth embodiment according to the present invention.

Table 5 is the fifth example of corresponding relations among user, predefined input data and control command in the embodiment, which is used for illustrating the corresponding relations in the embodiment. Preferably, Table 5 is saved in the storage unit 20 used as data (not shown in the diagrams). In the example illustrated in the following embodiment description with Table 5, the input/output unit 24 is an image capturing device, and the function is launching the predefined application.

TABLE 5

| user | predefined input data | control command |
|---|---|---|
| John | Left eye | Execute mail app |
| | Right Eye | Execute camera app |

The embodiment of the method of activate-upon-authentication comprises following steps:

Step S800: the electronic device 2 enters the configuration mode.

Step S802: the electronic device 2 accepts the user operation (i.e. the second user operation) of inputting an image capturing request (i.e. a second image capturing request).

For example, the user “John” moves to a location to make his left eye be within the shooting range of the image capturing device to automatically trigger the image capturing request (or manually trigger via pressing a key) in order to complete the user operation.

Step S804: the electronic device 2 captures a predefined input image (for example capturing a left eye image of the user “John”) as the predefined input data 200 (for example the predefined input data “left eye”) via the image capturing device according to the image capturing request.

Preferably, the electronic device 2 captures an iris image or a retinal image of either eye of the user.

Step S806: the electronic device 2 accepts the configuration operation by the user to make the predefined input data 200 correspond to the user identity and correspond to the control command 202 for triggering the function selected by the user (for example, in the embodiment, corresponding to the control command “Execute mail app”) and saves the corresponding relations.

Step S808: the electronic device 2 detects whether if the configuration mode is exited. If it detects that the configuration mode is not exited, the electronic device 2 can accept other user operations and configure corresponding users and corresponding control commands 202. Otherwise, the electronic device 2 executes the step S810.

Step S810: the electronic device 2 enters the authentication mode.

Step S812: the electronic device 2 accepts the user operation (i.e. the first user operation) of inputting an image capturing request (i.e. a first image capturing request).

For example, the user “John” moves to a location to make his right eye be within the shooting range of the image capturing device and manually or automatically triggers the image capturing request in order to complete the user operation.

Step S814: the electronic device 2 captures an input image (for example capturing a right eye image of the user “John”) used as the input data via the image capturing device according to the image capturing request.

Step S816: the electronic device 2 determines whether if the input data matches one of the plurality of predefined input data 200. If the electronic device 2 determines the input data matching one of the plurality of predefined input data 200, the user identity is authenticated, and the electronic device 2 executes step S818. Otherwise, the method of activate-upon-authentication is terminated by the electronic device 2.

For example, the electronic device 2 performs an inquiry in the Table 5 and a comparison to determine that the input data corresponds to the predefined input data “left eye” of the user “John”, and the user identity “John” is authenticated.

Step S818: electronic device 2 obtains the control command 202 corresponding to the predefined input data 200.

For example, the electronic device 2 obtains the control command “Execute camera app” corresponding to the predefined input data “left eye” according to Table 5.

Step S820: the electronic device 2 executes the obtained control command 202 (for example the control command “Execute camera app”) in order to trigger the function (in order to launch a camera application).

It should be noted that, in the embodiment, the examples of the predefined input image used for generating the predefined input data 200 and the input image used for generated the input data are the user's right eye image or left eye image, but is not limited thereto.

In another image of the present invention, the predefined input image and the input image for example are a palm prints image or a hand geometry image of user's either hand. Also alternatively, each palm prints image or hand geometry image corresponds to the same user, however respectively corresponds to different plurality of control commands 202.

Thus, the user performs authentication and respectively trigger different functions at the same time via placing the left hand or the right hand within the capturing range.

In another embodiment of the present invention, the predefined input image and the input image for example are a fingerprint image of one of the user's plurality of fingers or a vein image. Also alternatively, each finger's fingerprint image or the vein image corresponds to the same user, however respectively corresponds to a set of control commands 202.

Thus, the user performs authentication and respectively triggers different functions at the same time via placing different fingers within the capturing range.

In another image of the present invention, the predefined input image and the input image for example are a front face image or a side face image of the user. Also alternatively, the front face image and the side face image correspond to the same user, however respectively correspond to different plurality of control commands 202.

Thus, the user performs authentication and respectively triggers different functions at the same time via placing the front face or the side face within the capturing range.

It should be noted that, each person has different biological features (for example irises, retinas, palm prints, hand geometry, fingerprints, vein distribution or faces), in the embodiment of the method of activate-upon-authentication, the generated input data and the predefined input data 200 are to each user, even other people perform the same user operation, the generated input data is not completely identical.

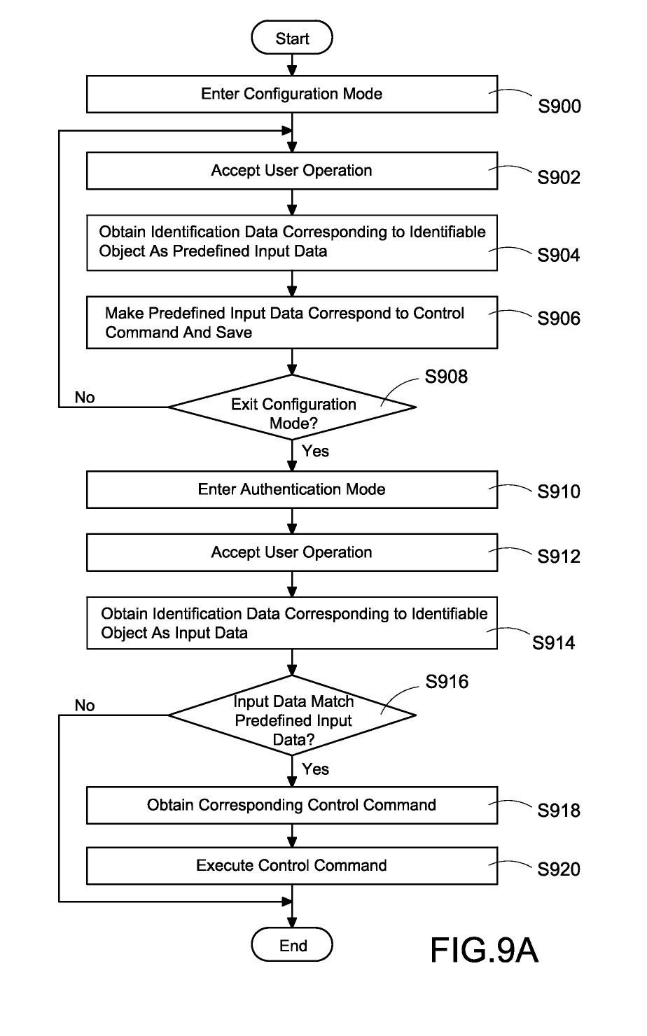

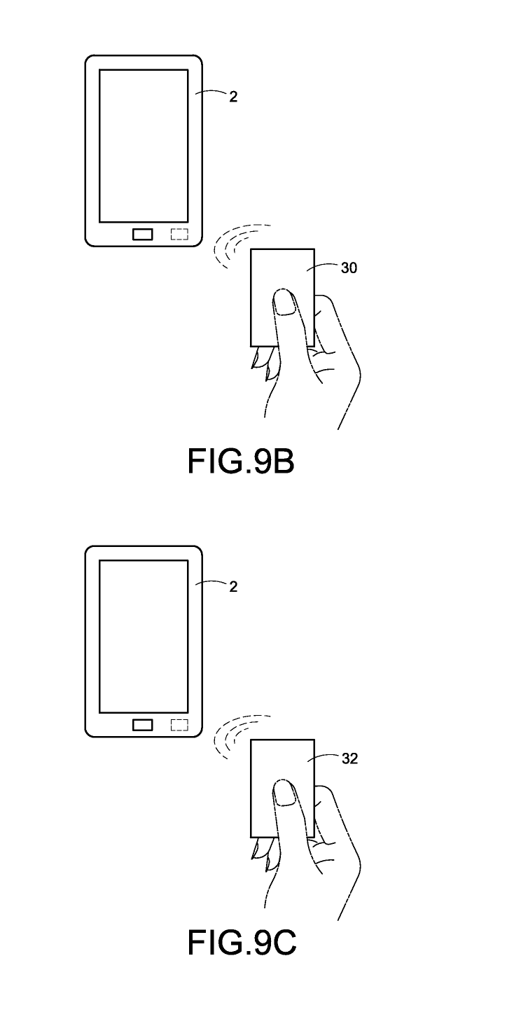

Refer to FIG. 9A, FIG. 9B and Table 6, FIG. 9A is a flowchart of the method of activate-upon-authentication of the seventh embodiment according to the present invention, and FIG. 9B is the first user operation schematic diagram of the seventh embodiment according to the present invention.

Table 6 is the sixth example of corresponding relations among user, predefined input data and control command in the embodiment, which is used for illustrating the corresponding relations in the embodiment. Preferably, and Table 6 is saved in the storage unit 20 used as data (not shown in the diagrams). In the example illustrated in the following embodiment description with Table 4, the input/output unit 24 is an object identification device, and the function is launching the predefined application.

TABLE 6

| user | predefined input data | control command |
|---|---|---|
| John | first tag | Execute notepad app |
| | second tag | Execute camera app |
| | third tag | Execute mail app |

The embodiment of the method of activate-upon-authentication comprises following steps:

Step S900: the electronic device 2 enters the configuration mode.

Step S902: the electronic device 2 accepts the user operation (i.e. the second user operation) of placing an identifiable object (i.e. a second identifiable object, for example an NFC tag) within the reading range of the object identification device (for example an NFC card reader).

For example, as the example shown in FIG. 9B, the user “John” has a plurality of the identifiable objects, and places one of the plurality of the identifiable objects (for example the identifiable object 30) within the reading range of the object identification device in the electronic device 2 in order to complete the user operation.

Step S904: the electronic device 2 obtains identification data corresponding to the identifiable object (i.e. second identification data, for example smart card number or object serial number) as the predefined input data 200 via the object identification device. Specifically, the identification data is recorded in the identifiable object, the electronic device 2 reads the identification data from the identifiable object by wired/wireless means via the object identification device.

For example, the electronic device 2 reads the identification data “first tag” of the identifiable object 30 used as the predefined input data 200 to process in the following steps.

Step S906: the electronic device 2 accepts the configuration operation by the user to make the predefined input data 200 correspond to the user identity and correspond to the control command 202 for triggering the function selected by the user (in the embodiment, for example corresponding to control command “Execute notepad app”) and saves the corresponding relations.

Step S908: the electronic device 2 detects whether if the configuration mode is exited. If it detects that the configuration mode is not exited, the electronic device 2 can accept other user operations and configure corresponding users and corresponding control commands 202. Otherwise, the electronic device 2 executes the step S910.

Step S910: the electronic device 2 enters the authentication mode.

Step S912: the electronic device 2 accepts the user operation (i.e. the first user operation) of placing an identifiable object (i.e. a first identifiable object) within the reading range of the object identification device.

For example, as the example shown in FIG. 9B, the user “John” places the held and recorded identifiable object 32 within the reading range of the object identification device in order to complete the user operation.

Step S914: the electronic device 2 obtains identification data corresponding the identifiable object (i.e. first identification data) used as the input data via the object identification device.

For example, the electronic device 2 reads the identification data “Card 2” of the identifiable object “Card 2” used as the input data to process in the following steps.

Step S916: the electronic device 2 determines whether if the input data matches one of the plurality of predefined input data 200. If the electronic device 2 determines the input data matching one of the plurality of predefined input data 200, the user identity is authenticated, and the electronic device 2 executes step S918. Otherwise, the method of activate-upon-authentication is terminated by the electronic device 2.

For example, the electronic device 2 performs an inquiry in the Table 6 and a comparison to determine that the input data corresponds to the predefined input data “second tag” of the user “John”, and the user identity “John” is authenticated.

Step S918: electronic device 2 obtains the control command 202 corresponding to the predefined input data 200.

For example, the electronic device 2 obtains the control command “Execute camera app” corresponding to the predefined input data “Card 2” according to Table 6.

Step S920: the electronic device 2 executes the obtained control command 202 in order to trigger the function.

For example, the electronic device 2 executes the control command “Execute camera app” in order to launch the camera application.

Thus, the user performs authentication and respectively triggers different functions at the same time via placing different held identifiable object within the reading range.

It should be noted that, in the embodiment, the example of the object identification device is an NFC card reader, and the example of the identifiable object is an NFC tag, and the scope is not limited thereto.

In another embodiment of the present invention, the object identification device is a barcode scanner or the wired smart card reader, the identifiable object can be a barcode or a smart card, and the scope is not limited thereto.

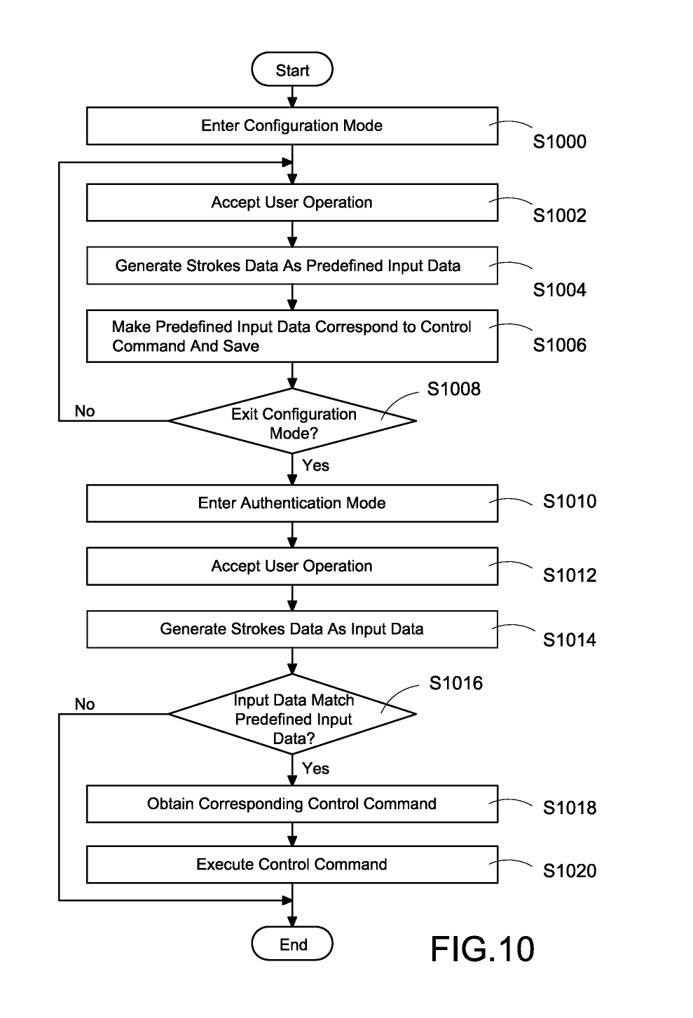

Refer to FIG. 10 and table 7, FIG. 10 is a flowchart of the method of activate-upon-authentication of the eighth embodiment according to the present invention.

Table 7 is the seventh example of corresponding relations among user, predefined input data and control command in the embodiment, which is used for illustrating the corresponding relations in the embodiment. Preferably, Table 7 is saved in the storage unit 20 used as data (not shown in the diagrams). In the example illustrated in the following embodiment description with Table 7, the input/output unit 24 is a writing input device, and the function is launching the predefined application.

TABLE 7

| user | predefined input data | control command |
|---|---|---|
| John | NOTEPAD | Execute notepad app |
| | CAMERA | Execute camera app |
| | EMAIL | Execute mail app |

The embodiment of the method of activate-upon-authentication comprises following steps:

Step S1000: the electronic device 2 enters the configuration mode.

Step S1002: the electronic device 2 accepts the user operation (i.e. the second user operation) of inputting a plurality of strokes (i.e. a plurality of second strokes) via writing.

For example, the user “John” writes a word “NOTEPAD” on the writing input device in order to input the plurality of strokes in the word “NOTEPAD”.

Step S1004: the electronic device 2 generates strokes data (i.e. second strokes data) used as the predefined input data 200 according to the plurality of strokes.

For example, the electronic device 2 generates the strokes data “NOTEPAD” corresponding to the plurality of strokes in the word “NOTEPAD” used as the predefined input data 200 to process in the following steps.

Step S1006: the electronic device 2 accepts the configuration operation by the user to make the predefined input data 200 correspond to the user identity and correspond to the control command 202 for triggering the function selected by the user (in the embodiment, for example corresponding to the control command “Execute notepad app”) and saves the corresponding relations.

Step S1008: the electronic device 2 detects whether if the configuration mode is exited. If it detects that the configuration mode is not exited, the electronic device 2 accept other user operations and configure corresponding users and corresponding control commands 202. Otherwise, the electronic device 2 executes the step S1010.

Step S1010: the electronic device 2 enters the authentication mode.

Step S1012: the electronic device 2 accepts the user operation (i.e. the first user operation) of inputting a plurality of strokes (i.e. a plurality of first strokes) via writing.

For example, the user “John” writes a word “CAMERA” on the writing input device in order to input the plurality of strokes in the word “CAMERA”.

Step S1014: generates the strokes data (i.e. first strokes data) used as the input data according to the plurality of strokes.

For example, the electronic device 2 generates the strokes data “CAMERA” corresponding to the plurality of strokes in the word “CAMERA” used as the input data.

Step S1016: the electronic device 2 determines whether if the input data matches one of the plurality of predefined input data 200. If the electronic device 2 determines the input data matching one of the plurality of predefined input data 200, the user identity is authenticated, and the electronic device 2 executes step S1018. Otherwise, the method of activate-upon-authentication is terminated by the electronic device 2.

For example, the electronic device 2 performs an inquiry in the Table 7 and a comparison to determine that the input data corresponds to the predefined input data “CAMERA” of the user “John”, and the user identity “John” is authenticated.

Step S1018: electronic device 2 obtains the control command 202 corresponding to the predefined input data 200.

For example, the electronic device 2 obtains the control command “Execute camera app” corresponding to the predefined input data “CAMERA” according to Table 7.

Step S1020: the electronic device 2 executes the obtained control command 202 in order to trigger the function.

For example, the electronic device 2 executes the control command “Execute camera app” in order to launch the camera application.

Thus, the user performs authentication and respectively triggers different functions at the same time via writing different words.

It should be noted that, each person writes different strokes, in the embodiment of the method of activate-upon-authentication, the generated input data and the predefined input data 200 are unique to each user, providing other people perform the same user operation, the input data generated is not completely identical.

It should be noted that, in the above-mentioned embodiment, the control command 202 is used for launching specific application, and the scope is not limited thereto.

In another embodiment of the present invention, the control command 202 is used for executing predefined device control (for example connecting to a specific network, entering a power saving mode or powering off).

The method of the present invention performs authentication and executes corresponding function according to user operation corresponding to the function required to trigger at the same time, which eliminates the need to perform extra identification data input operation.

As the skilled person will appreciate, various changes and modifications can be made to the described embodiment. It is intended to include all such variations, modifications and equivalents which fall within the scope of the present invention, as defined in the accompanying claims.

What is claimed is:

1. A method of activate-upon-authentication for an electronic device, comprising following steps:
a) accepting a first user operation corresponding to a function input by a user;
b) generating input data corresponding to the first user operation;
c) when the input data upon determined matching one of a plurality of predefined input data established previously, authenticating a user identity, and simultaneously obtaining a control command corresponding to the predefined input data for triggering the function; and
d) executing the control command for triggering the function.

2. The method of activate-upon-authentication of claim 1, wherein the method further comprises following steps before the step a:
e1) accepting a second user operation under a configuration mode;
e2) generating operation data corresponding to the second user operation used as one the plurality of predefined input data; and
e3) establishing and saving a corresponding relation among the predefined input data, the user identity and the control command for triggering the function selected by the user according to a configuration operation.

3. The method of activate-upon-authentication of claim 2, wherein the function is launching a predefined application and/or executing a predefined device control.

4. The method of activate-upon-authentication of claim 3, wherein the electronic device comprises a motion sensor; the step a comprises a step a1: accepting the first user operation of moving the electronic device along a first path in the air; and the step b comprises a step b1: sensing a first motion sensor value corresponding to the first user operation used as the input data via the motion sensor.

5. The method of activate-upon-authentication of claim 4, wherein the step e1 comprises a step e11: accepting the second user operation of moving the electronic device along a second path in the air; and the step e2 comprises a step e21: sensing a second motion sensor value corresponding to the second user operation used as the input data via the motion sensor.

6. The method of activate-upon-authentication of claim 3, wherein the electronic device comprises an input/output unit; the step a comprises a step a2: displaying a plurality of first pictures in the input/output unit, and a step a3: accepting the first user operation of selecting parts of the plurality of first pictures via the input/output unit; and the step b comprises a step b2: generating the input data according to selected parts of the plurality of first pictures and a first sequence of selected parts of the plurality of first pictures.

7. The method of activate-upon-authentication of claim 6, wherein the step e1 comprises a step e12: displaying a plurality of second pictures in the input/output unit, wherein the plurality of second pictures are at least partially the same with the plurality of first pictures, and e13: accepting the second user operation of selecting parts of the plurality of second pictures via the input/output unit; and the step e2 comprising a step e22: generating the predefined input data according to the selected parts of the plurality of second pictures and a second sequence of selected parts of the plurality of second pictures.

8. The method of activate-upon-authentication of claim 3, wherein the electronic device comprises an audio input device; the step a comprises a step a4: accepting the first user operation of input a first voice message via the audio input device; and the step b comprises a step b3: generating a first voice data used as the input data according to the first voice message.

9. The method of activate-upon-authentication of claim 8, wherein the step e1 comprises a step e14: accepting the second user operation of input a second voice message via the audio input device; and the step e2 comprises a step e23: generating a second voice data used as the predefined input data according to the second voice message.

10. The method of activate-upon-authentication of claim 3, wherein the electronic device comprises a image capturing device; the step a comprises a step a5: accepting the first user operation of inputting a first image capturing request; and the step b comprises a step b4: capturing an input image used as the input data via the image capturing device according to the first image capturing request.

11. The method of activate-upon-authentication of claim 10, wherein the step e1 comprises a step e15: accepting the second user operation of inputting a second image capturing request; and the step e2 comprises a step e24: capturing a predefined input image used as the predefined input data via the image capturing device according to the second image capturing request.

12. The method of activate-upon-authentication of claim 11, wherein the predefined input image and the input image are a retinal image or an iris image from one of two eyes of the user.

13. The method of activate-upon-authentication of claim 11, wherein the predefined input image and the input image are a palm prints image or a hand geometry image from one of two hands of the user.

14. The method of activate-upon-authentication of claim 11, wherein the predefined input image and the input image are a vein image or a fingerprints image from one of a plurality of user fingers.

15. The method of activate-upon-authentication of claim 11, wherein the predefined input image and the input image are a front face image or a side face image of the user.

16. The method of activate-upon-authentication of claim 3, wherein the electronic device comprises an object identification device; the step a comprises a step a6: accepting the first user operation of placing a first identifiable object within a reading range of the object identification device; and the step b comprises a step b5: obtaining first identification data of the first identifiable object used as the input data via the object identification device.

17. The method of activate-upon-authentication of claim 16, wherein the step e1 comprises a step e16: accepting the second user operation of placing a second identifiable object within a reading range of the object identification device; and the step e2 comprises a step e25: obtaining second identification data of the second identifiable object used as the predefined input data via the object identification device.

18. The method of activate-upon-authentication of claim 17, wherein the object identification device is a smart card reader; the first identifiable object is a smart card saved with the first identification data; and the second identifiable object is a smart card saved with the second identification data.

19. The method of activate-upon-authentication of claim 3, wherein the electronic device comprises a writing input device; the step a comprises a step a7: accepting the first user operation of inputting a plurality of first strokes by writing; and the step b comprises a step b6: generating a first stroke data used as the input data according to the plurality of first strokes.

20. The method of activate-upon-authentication of claim 19, wherein the step e1 comprises a step e17: accepting the second user operation of inputting a plurality of second strokes by writing; and the step e2 comprises a step e26: generating a second stroke data used as the predefined input data according to the plurality of second strokes.
